(19) United States
(12) Patent Application Publication
(10) Pub. No.: US 2009/0080866 A1
(43) Pub. Date: Mar. 26, 2009

(54) Video Substitution System

(75) Inventor: Colin John Davies, Hampshire (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS LIMITED, MIDDLESEX (GB)

(21) Appl. No.: 12/087,808

(22) PCT Filed: Jan. 15, 2007
(86) PCT No.: PCT/GB2007/000098

§ 371 Date: Aug. 14, 2008

Related U.S. Application Data
(60) Provisional application No. 60/786,270, filed on Mar. 27, 2006.

(51) Int. Cl. H04N 7/12; H04N 7/26

(52) U.S. Cl. 386/124; 375/240.01; 375/E07.076

(57) ABSTRACT

A video substitution method for use with a Digital Video Recorder (DVR) which is operative to store video is disclosed. The method includes retrieving stored video recorded from a single video stream which includes a first positive integer n1 down-sampled video sequences, the n1 down-sampled video sequences being mutually synchronized and formatted in a second positive integer n2 video frames, each video frame comprising n1 spatially combined sub-pictures each of which corresponds to one frame of the n1 down-sampled video sequences, up-sampling at least part of a first one of the n1 down-sampled video sequences, thereby producing a first up-sampled video sequence, displaying the first up-sampled video sequence on a display during normal content viewing, detecting activation of a trick mode including one of the following: a fast forward mode; and a rewind mode, and in response to the detecting: up-sampling at least part of a second one of the n1 down-sampled video sequences, thereby producing a second up-sampled video sequence, and displaying the second up-sampled video sequence instead of the first up-sampled video sequence during at least part of an activation period of the trick mode. Related apparatus and methods are also disclosed.

### CROSS-REFERENCE TO RELATED APPLICATIONS

The present application claims priority from U.S. Provisional Patent Application Ser. No. 60/786,270, filed 27 Mar. 2006, the disclosure of which is hereby incorporated herein by reference.

### FIELD OF THE INVENTION

The present invention generally relates to Digital Video Recorders VRs).

### BACKGROUND OF THE INVENTION

Digital Video Recorders (DVRs), also known as Personal Video Recorders (PVRs), are typically used for digital recording of television programs and time-shifted playback of recorded television programs. During such time-shifted playback, many viewers tend to use fast forward and rewind features which are enabled by many DVRs in order to skip commercials. Skipping commercials reduces effectiveness of conventional television advertising and creates a problem for advertisers.

Some aspects of technologies and related material that may be useful in understanding the present invention are described in the following publications:

Published PCT Patent Application WO 2005/096625 of NDS Limited, which describes a system for providing visible messages during PVR trick mode playback;

Published PCT Patent Application WO 2004/072935 of NDS Limited, which describes apparatus and methods for handling interactive applications in broadcast networks;

Published PCT Patent Application WO 02/01866 of NDS Limited, and corresponding U.S. patent application Ser. No. 10/297,453 of Tsuria et al, which describe time shifted interactive television;

Published PCT Patent Application WO 00/01149 of NDS Limited, corresponding European Patent EP 1013088 of NDS Limited, and corresponding U.S. patent application Ser. No. 09/515,118 of Wachtfogel et al, which describe an advanced television system; and

Published PCT Patent Application WO 01/52541 of NDS Limited, and corresponding U.S. patent application Ser. No. 09/914,747 of Wachtfogel et al, which describe advertisements in an end user controlled playback environment.

The disclosures of all references mentioned above and throughout the specification, as well as the disclosures of all references mentioned in those references, are hereby incorporated herein by reference.

### SUMMARY OF THE INVENTION

The present invention, in preferred embodiments thereof, seeks to provide a video substitution system and method in which a Digital Video Recorder (DVR) is operative, during at least part of an activation period of a trick mode comprising a fast forward mode or a rewind mode, to substitute video displayed during normal content viewing with alternative video. The DVR preferably receives a single video stream comprising the video displayed during normal content viewing and the alternative video, where the video displayed during normal content viewing and the alternative video are down-sampled and spatially combined. Each of the video displayed during normal content viewing and the alternative video is preferably, in its turn, up-sampled for display.

There is thus provided in accordance with a preferred embodiment of the present invention a video substitution method for use with a Digital Video Recorder (DVR) which is operative to store video, the method including retrieving stored video recorded from a single video stream which includes a first positive integer n1 down-sampled video sequences, the n1 down-sampled video sequences being mutually synchronized and formatted in a second positive integer n2 video frames, each video frame including n1 spatially combined sub-pictures each of which corresponds to one frame of the n1 down-sampled video sequences, up-sampling at least part of a first one of the n1 down-sampled video sequences, thereby producing a first up-sampled video sequence, displaying the first up-sampled video sequence on a display during normal content viewing, detecting activation of a trick mode including one of the following: a fast forward mode, and a rewind mode, and in response to the detecting: up-sampling at least part of a second one of the n1 down-sampled video sequences, thereby producing a second up-sampled video sequence, and displaying the second up-sampled video sequence instead of the first up-sampled video sequence during at least part of an activation period of the trick mode.

Preferably, the retrieved video is associated with signaling information which signals the DVR to perform the up-sampling.

By way of a non-limiting example, n1 equals two.

Preferably, the second one of the n1 down-sampled video sequences includes advertisement information.

Further preferably, the second one of the n1 down-sampled video sequences is tailored to provide a better viewing experience during trick mode playing than the first one of the n1 down-sampled video sequences.

Still further preferably, the n2 video frames include coded video frames.

The coded video frames preferably include MPEG coded video frames. The MPEG coded video frames preferably include at least one of the following: MPEG-2 coded video frames, and MPEG-4 coded video frames.

There is also provided in accordance with a preferred embodiment of the present invention a Digital Video Recorder (DVR) including a memory which stores video, and a DVR processing element which is operative to perform the following: retrieve, from the memory, stored video recorded from a single video stream which includes a first positive integer n1 down-sampled video sequences, the n1 down-sampled video sequences being mutually synchronized and formatted in a second positive integer n2 video frames, each video frame including n1 spatially combined sub-pictures each of which corresponds to one frame of the n1 down-sampled video sequences, up-sample at least part of a first one of the n1 down-sampled video sequences, thereby producing a first up-sampled video sequence, display the first up-sampled video sequence on a display during normal content viewing, detect activation of a trick mode including one of the following: a fast forward mode, and a rewind mode, and in response to detection of the activation of the trick mode: up-sample at least part of a second one of the n1 down-sampled video sequences, thereby producing a second up-sampled video sequence, and display the second up-sampled video sequence on the display instead of the first up-sampled video sequence during at least part of an activation period of the trick mode.

### BRIEF DESCRIPTION OF THE DRAWINGS

The present invention will be understood and appreciated more fully from the following detailed description, taken in conjunction with the drawings in which:

FIGS. 1A and 1B together constitute a simplified partly pictorial, partly block diagram illustration of a video substitution system constructed and operative in accordance with a preferred embodiment of the present invention;

FIG. 2 is a simplified flowchart illustration of a preferred method of operation of a DVR in the system of FIGS. 1A and 1B; and

FIG. 3 is a simplified partly pictorial, partly block diagram illustration representing a single video sequence that is composed from two synchronized video sequences that have been horizontally down-sampled by a factor of two and placed side by side, and up-sampling of a first one of the two down-sampled synchronized video sequences for normal video viewing and of a second one of the two down-sampled synchronized video sequences for viewing during a trick mode.

### DETAILED DESCRIPTION OF A PREFERRED EMBODIMENT

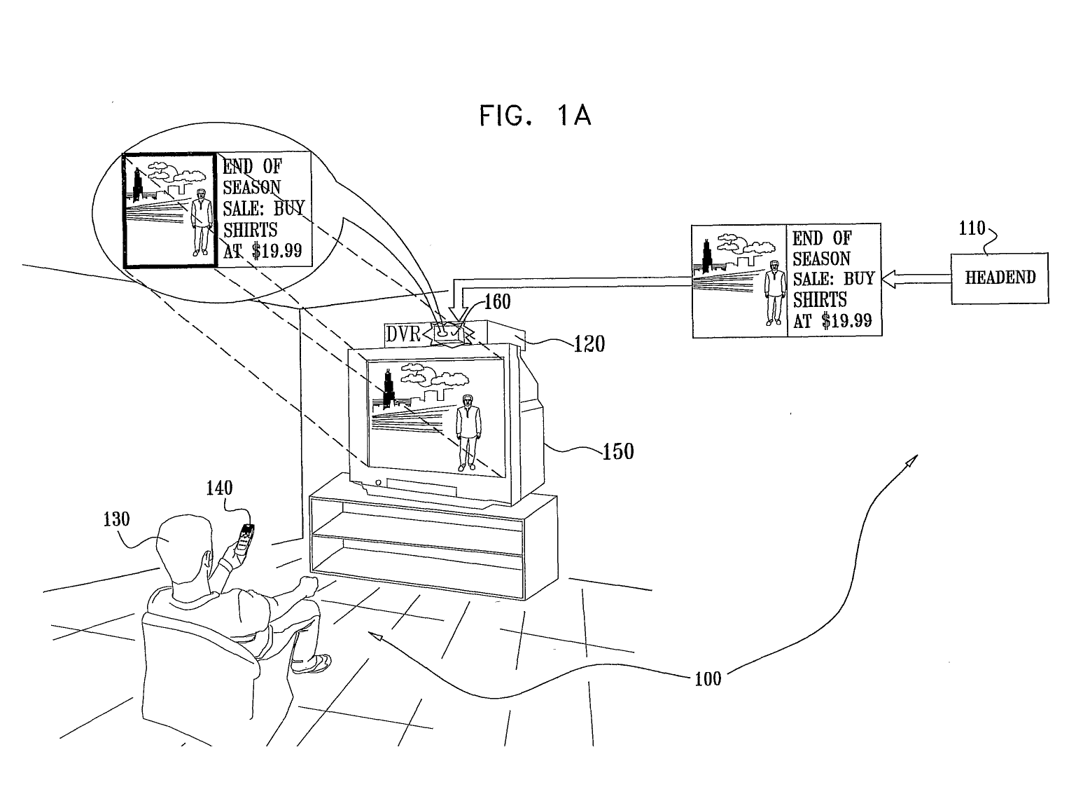

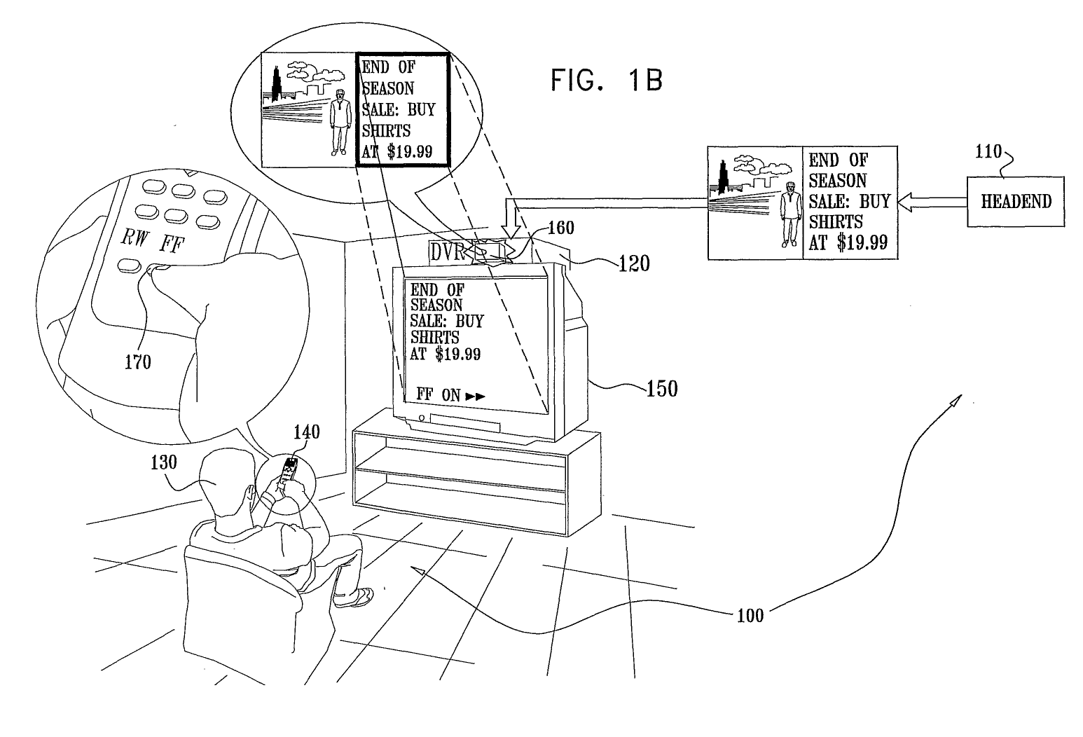

Reference is now made to FIGS. 1A and 1B, which together constitute a simplified partly pictorial, partly block diagram illustration of a video substitution system 100 constructed and operative in accordance with a preferred embodiment of the present invention.

In the system 100, a headend 110 broadcasts or otherwise delivers video, audio and signaling information. The video, the audio and the signaling information broadcasted or otherwise delivered by the headend 110 preferably pertain to at least one of the following: pay and/or non-pay television programs; multimedia information; audio programs; data; games; and information from computer based networks such as the Internet.

The signaling information is preferably associated with the video and is used to signal that the video comprises down-sampled parts which are intended to be up-sampled for display. The audio preferably includes one or more sound tracks which accompany the video.

Preferably, the headend 110 broadcasts or otherwise delivers the video, the audio and the signaling information via at least one of the following (all not shown): a satellite based communication network; a cable based communication network; a conventional terrestrial broadcast television network; a telephony based television delivery network; a mobile-telephony based television delivery network; and an Internet Protocol (IP) based television delivery network. Persons skilled in the art will appreciate that any appropriate broadcast or delivery technology may be used.

One non-limiting example of an appropriate telephony or IP based television delivery network is the Synamedia™ system, commercially available from NDS Limited, One Heathrow Boulevard, 286 Bath Road, West Drayton, Middlesex UB7 0DQ, United Kingdom.

Preferably, the video, the audio and the signaling information broadcasted or otherwise delivered by the headend 110 are received at a Digital Video Recorder (DVR) 120. The DVR 120 may, for example, be located at a site of a user 130 and controlled by the user 130 via a remote control (RC) 140.

The DVR 120 is typically used for digital recording of television programs and time-shifted playback of recorded television programs. The DVR 120 includes a high-capacity memory and conventional DVR circuitry (both not shown) as used in conventional DVRs. Non-limiting examples of conventional DVRs well known in the art include: the system described in Published PCT Patent Application WO 00/01149 of NDS Limited, corresponding European Patent EP 1013088 of NDS Limited, and corresponding U.S. patent application Ser. No. 09/515,118 of Wachtfogel et al, referred to above and incorporated herein by reference; and the XTV™ system, commercially available from NDS Limited, One Heathrow Boulevard, 286 Bath Road, West Drayton, Middlesex UB7 0DQ, United Kingdom. DVRs are also known as Personal Video Recorders (PVRs).

Preferably, the DVR 120 stores the broadcast or otherwise delivered video and audio and the signaling information in the high-capacity memory and uses the conventional DVR circuitry for decoding and processing video and audio retrieved from the high-capacity memory for display on a display 150. The display 150 may preferably comprise any appropriate display such as, for example: a television; or a computer monitor comprising speakers.

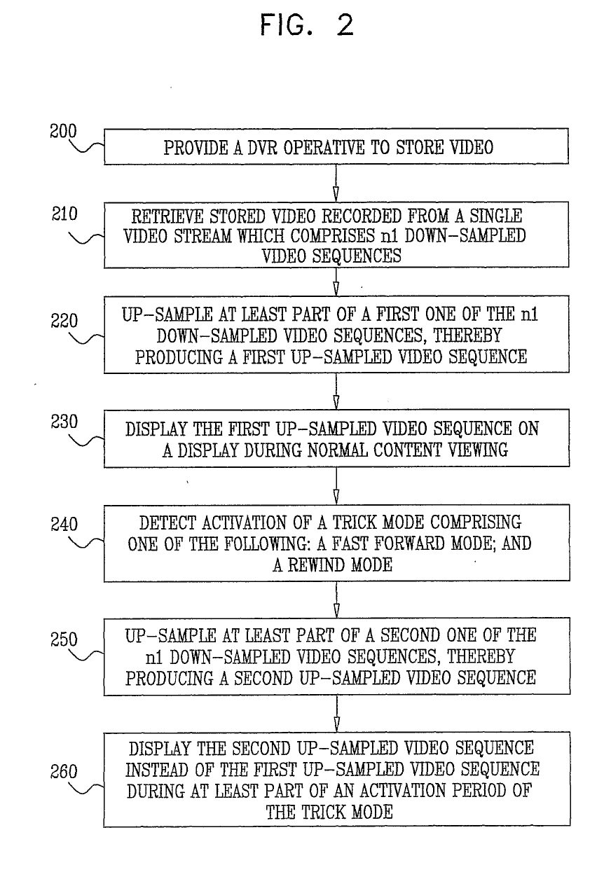

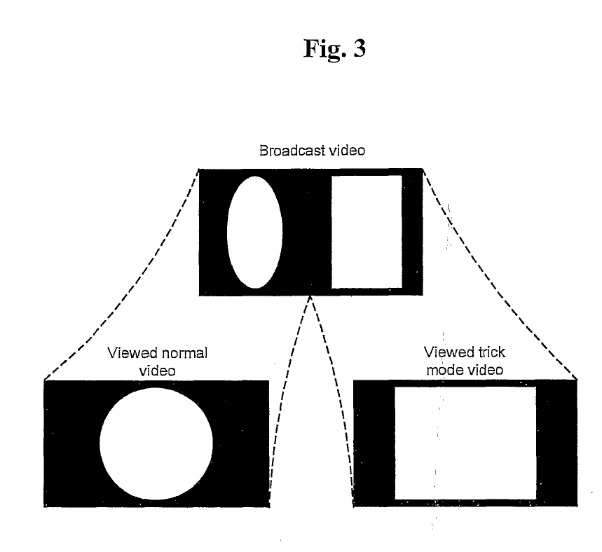

In accordance with a preferred embodiment of the present invention the DVR 120 also includes, in addition to the high capacity memory and the conventional DVR circuitry, a DVR processing element 160 which is implemented in software or in a combination of software and hardware. The DVR processing element 160 preferably provides functionality, as described herein with reference to FIGS. 1A, 1B, and 2, which pertains, inter alia, to the following: video retrieval; determination, in accordance with the signaling information, whether to up-sample down-sampled parts of retrieved video; and up-sampling and display of down-sampled parts of the retrieved video as necessary. Persons skilled in the art will appreciate that hardware components of the DVR processing element 160 may be comprised in the DVR circuitry and/or associated with the DVR circuitry, and software components of the DVR processing element 160 may be inserted into and/or associated with conventional DVR software and/or firmware.

In operation, the DVR 120, using the DVR processing element 160, retrieves stored video recorded from a single video stream. The single video stream preferably comprises a first plurality of down-sampled video sequences, where a positive integer n1 indicates the number of down-sampled video sequences. The n1 down-sampled video sequences are preferably mutually synchronized and formatted in a second plurality of video frames, where a positive integer n2 indicates the number of video frames. Preferably, each of the n2 video frames comprises n1 spatially combined sub-pictures, each of which corresponds to one frame of the n1 down-sampled video sequences.

Preferably, the n2 video frames comprise coded video frames. The coded video frames preferably comprise MPEG (MPEG—Moving Picture Experts Group) coded video frames comprising at least one of the following: MPEG-2 coded video frames; and MPEG-4 coded video frames.

By way of a non-limiting example and for the sake of simplicity of description, FIGS. 1A and 1B depict a case in which n1 equals two, it being appreciated that n1 may alternatively be greater than two. When n1=2, down-sampling of video results, for example, in a reduction of horizontal resolution of the video by a factor of two.

In addition to retrieval of the stored video recorded from a single video stream the DVR 120 also preferably retrieves stored audio which accompanies the retrieved video and stored signaling information which is associated with the retrieved video.

Preferably, the DVR 120, using the DVR processing element 160, up-samples at least part of a first one of the n1 down-sampled video sequences, thereby producing a first up-sampled video sequence. The DVR 120 then preferably displays the first up-sampled video sequence on the display 150 during normal content viewing. Also, during normal content viewing, the DVR 120 provides the audio which accompanies the first one of the n1 down-sampled video sequences to the display 150 for playing. Display of the first up-sampled video sequence on the display 150 is depicted in FIG. 1A.

Typically, the DVR 120 enables the user 130 to activate a trick mode comprising one of the following: a fast forward (FF) mode; and a rewind (RW) mode. The user 130 may preferably activate the trick mode by pressing on an appropriate key on the RC 140. By way of a non-limiting example, the user 130 is shown in FIG. 1B pressing a fast forward (FF) key 170 on the RC 140.

Preferably, upon the DVR 120 detecting activation of such a trick mode, the DVR 120 not only performs the trick mode but also preferably up-samples, using the DVR processing element 160, at least part of a second one of the n1 down-sampled video sequences, thereby producing a second up-sampled video sequence. The DVR 120 then preferably displays the second up-sampled video sequence instead of the first up-sampled video sequence during at least part of an activation period of the trick mode. Display of the second up-sampled video sequence on the display 150 is depicted in FIG. 1B.

It is appreciated that up-sampling of the at least part of the first one of the n1 down-sampled video sequences and of the at least part of the second one of the n1 down-sampled video sequences is preferably performed in accordance with the signaling information which signals the DVR processing element 160 to perform the up-sampling. The signaling information preferably signals the DVR processing element 160 to perform the up-sampling, for example, by employing a flag whose value determines whether up-sampling of video portions associated with the flag is to be performed.

For example, the flag may be assigned a value of “0” to indicate that up-sampling of associated video is not to be performed and a value of “1” to indicate that up-sampling of the associated video is to be performed. The DVR processing element 160 preferably checks a value of the flag associated with each video portion, and up-samples video portions in which the flag associated therewith is assigned a value of “1” and does not up-sample video portions in which the flag associated therewith is assigned a value of “0”.

Preferably, the DVR processing element 160 also enables switching from displaying the first up-sampled video sequence to displaying the second up-sampled video sequence during at least part of an activation period of a trick mode only if the at least part of the activation period of the trick mode occurs during display of up-sampled video, that is, video having the flag associated therewith assigned a value of “1”.

The first one of the nil down-sampled video sequences typically includes a television program which the user 130 views during normal content viewing. The second one of the n1 down-sampled video sequences may preferably comprise advertisement information, and thus during the at least part of the activation period of the trick mode the advertisement information is preferably displayed to the user 130. As the at least part of the activation period of the trick mode is ended, the DVR processing element 160 returns to up-sampling the first one of the n1 down-sampled video sequences and the DVR 120 therefore returns to displaying the first up-sampled video sequence on the display 150. Thus, advertisement information is displayed without interfering user activity, and effectiveness of conventional television advertising is maintained.

It is appreciated that the second one of the n1 down-sampled video sequences may alternatively comprise, for example, synopsis information for a program being viewed during normal content viewing or trailers for other content or advertising material.

It is further appreciated that during activation of the trick mode the retrieved video comprising all the n1 down-sampled video sequences is decoded. Therefore, the second one of the n1 down-sampled video sequences which is displayed during the at least part of the activation period of the trick mode is displayed at a speed of the trick mode which is different than normal display speed. Typically, display of television content at a trick mode speed results in a poor viewing experience as is well known today in television systems. However, since the second one of the n1 down-sampled video sequences is intended for viewing only during trick mode playing, a creator of the second one of the n1 down-sampled video sequences, such as a broadcaster/content provider, may preferably tailor the second one of the n1 down-sampled video sequences before broadcasting to provide a better viewing experience during trick mode playing than, for example, the first one of the n1 down-sampled video sequences would have provided if it were up-sampled and displayed during trick mode playing. Additionally, the creator of the second one of the n1 down-sampled video sequences may also tailor the second one of the n1 down-sampled video sequences before broadcasting to be coding efficient.

For example, the broadcaster/content provider may tailor the second one of the n1 down-sampled video sequences to include only a still image or a slide with advertisement information, which still image or slide does not change during trick mode playing and thus display of the still image or slide provides a good viewing experience.

Further for example, if the retrieved video is coded in MPEG-2, the broadcaster/content provider may tailor the second one of the n1 down-sampled video sequences to only change frame content of frames to be encoded as I-frames. The frame content of each such frame is preferably repeated until another I-frame is reached such that predictive coding employed in MPEG-2 P-frames and B-frames may represent the video of the second one of the n1 down-sampled video sequences efficiently using a lower number of bits than normally used in coding of conventional video. Coding and decoding thus become efficient because they are performed only on I-frames.

It is appreciated that a good coding efficiency may be obtained even when a rate of change of video frames in the second one of the n1 down-sampled video sequences is not synchronized with I-frame encoding.

If the trick mode is activated in order to skip a commercial, the advertisement information may include a different commercial or an advertising message which would not be seen in normal viewing. The advertising message may span throughout an entire commercial break, so that rather than viewing, for example, a fast forwarded commercial having a poor viewing experience due to fast forwarding, the user 130 is presented with a more concise advertising message having a good viewing experience which is comparable to viewing experience in normal television viewing.

In a case where n1 is greater than two, there is more than one down-sampled video sequence available for viewing during trick mode playing, such as n3 down-sampled video sequences, where n3 is a positive integer greater than one. In such a case, each of the n3 down-sampled video sequences may include a different advertising message, and each such different advertising message may be targeted to different users based on demographic information of such users. Such targeted advertisement is typically appealing to advertisers. Additionally, a countdown to restart of normal programming may be overlaid on any one of or some of the different advertising messages thus adding functionality that also appeals to the users.

It is appreciated that various sub-combinations of the system 100 of FIGS. 1A and 1B may comprise alternative preferred embodiments of the present invention. For example, and without limiting the generality of the foregoing, each of the following may comprise an alternative preferred embodiment of the present invention: the DVR 120; and the DVR processing element 160.

Reference is now made to FIG. 2, which is a simplified flowchart illustration of a preferred method of operation of the DVR 120 in the system 100 of FIGS. 1A and 1B.

A DVR which is operative to store video is preferably provided (step 200). Preferably, stored video recorded from a single video stream is retrieved (step 210) at a selection of a user. The single video stream preferably comprises a first plurality of down-sampled video sequences, where a positive integer n1 indicates the number of down-sampled video sequences. The n1 down-sampled video sequences are preferably mutually synchronized and formatted in a second plurality of video frames, where a positive integer n2 indicates the number of video frames. Preferably, each of the n2 video frames comprises n1 spatially combined sub-pictures, each of which corresponds to one frame of the n1 down-sampled video sequences.

Further preferably, at least part of a first one of the n1 down-sampled video sequences is up-sampled (step 220), thereby producing a first up-sampled video sequence. The first up-sampled video sequence is preferably displayed (step 230) on a display during normal content viewing.

Preferably, upon detecting (step 240) activation of a trick mode, at least part of a second one of the n1 down-sampled video sequences is up-sampled (step 250), thereby producing a second up-sampled video sequence. The second up-sampled video sequence is then preferably displayed (step 260) instead of the first up-sampled video sequence during at least part of an activation period of the trick mode.

The trick mode preferably comprises one of the following: a fast forward mode; and a rewind mode. It is appreciated that the second one of the n1 down-sampled video sequences is preferably tailored to provide a better viewing experience during trick mode playing than, for example, the first one of the n1 down-sampled video sequences would have provided if it were up-sampled and displayed during trick mode playing. Additionally, the second one of the n1 down-sampled video sequences may also be tailored to be coding efficient.

A further particularly detailed description of one possible implementation of the preferred embodiment is provided in Appendix A, which is titled “Method for the delivery and display of an alternative video during fast forward or rewind through recorded broadcast content”. Appendix A is a document which will aid in understanding certain preferred embodiments of the present invention. The implementation of Appendix A is not meant to be limiting.

It is appreciated that software components of the present invention may, if desired, by implemented in ROM (read only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the claims which follow.

1-9. (canceled)

10. A video substitution method for use with a Digital Video Recorder (DVR) which is operative to store video, the method comprising:
retrieving stored video recorded from a single video stream which comprises a first positive integer n1 down-sampled video sequences, the n1 down-sampled video sequences being mutually synchronized and formatted in a second positive integer n2 video frames, each video frame comprising n1 spatially combined sub-pictures each of which corresponds to one frame of the n1 down-sampled video sequences;
up-sampling at least part of a first one of the n1 down-sampled video sequences, thereby producing a first up-sampled video sequence;
displaying the first up-sampled video sequence on a display during normal content viewing;
detecting activation of a trick mode comprising one of the following: a fast forward mode; and a rewind mode; and
in response to the detecting:
up-sampling at least part of a second one of the n1 down-sampled video sequences, thereby producing a second up-sampled video sequence; and
displaying the second up-sampled video sequence instead of the first up-sampled video sequence during at least part of an activation period of the trick mode.

11. The method according to claim 10 and wherein the retrieved video is associated with signaling information which signals the DVR to perform the up-sampling.

12. The method according to claim 10 and wherein n1 equals two.

13. The method according to claim 10 and wherein the second one of the n1 down-sampled video sequences comprises advertisement information.

14. The method according to claim 10 and wherein the second one of the n1 down-sampled video sequences is tailored to provide a better viewing experience during trick mode playing than the first one of the n1 down-sampled video sequences.

15. The method according to claim 10 and wherein the n2 video frames comprise coded video frames.

16. The method according to claim 15 and wherein the coded video frames comprise MPEG coded video frames.

17. The method according to claim 16 and wherein the MPEG coded video frames comprise at least one of the following: MPEG-2 coded video frames; and MPEG-4 coded video frames.

18. A Digital Video Recorder (DVR) comprising:
a memory storing video; and
a DVR processing element which is operative to perform the following:
retrieve, from the memory, stored video recorded from a single video stream which comprises a first positive integer n1 down-sampled video sequences, the n1 down-sampled video sequences being mutually synchronized and formatted in a second positive integer n2 video frames, each video frame comprising n1 spatially combined sub-pictures each of which corresponds to one frame of the n1 down-sampled video sequences;
up-sample at least part of a first one of the n1 down-sampled video sequences, thereby producing a first up-sampled video sequence;
display the first up-sampled video sequence on a display during normal content viewing;
detect activation of a trick mode comprising one of the following: a fast forward mode; and a rewind mode; and
in response to detection of the activation of the trick mode:
up-sample at least part of a second one of the n1 down-sampled video sequences, thereby producing a second up-sampled video sequence; and
display the second up-sampled video sequence on the display instead of the first up-sampled video sequence during at least part of an activation period of the trick mode.

19. The DVR according to claim 18 and wherein the retrieved video is associated with signaling information which signals the DVR to perform up-sampling.

20. The DVR according to claim 18 and wherein n1 equals two.

21. The DVR according to claim 18 and wherein the second one of the n1 down-sampled video sequences comprises advertisement information.

22. The DVR according to claim 18 and wherein the second one of the n1 down-sampled video sequences is tailored to provide a better viewing experience during trick mode playing than the first one of the n1 down-sampled video sequences.

23. The DVR according to claim 18 and wherein the n2 video frames comprise coded video frames.

24. The DVR according to claim 23 and wherein the coded video frames comprise MPEG coded video frames.

25. The DVR according to claim 24 and wherein the MPEG coded video frames comprise at least one of the following: MPEG-2 coded video frames; and MPEG-4 coded video frames.

26. A Digital Video Recorder (DVR) comprising:
means for storing video; and
means for processing which is operative to perform the following:
retrieve, from the means for storing, stored video recorded from a single video stream which comprises a first positive integer n1 down-sampled video sequences, the n1 down-sampled video sequences being mutually synchronized and formatted in a second positive integer n2 video frames, each video frame comprising n1 spatially combined sub-pictures each of which corresponds to one frame of the n1 down-sampled video sequences;
up-sample at least part of a first one of the n1 down-sampled video sequences, thereby producing a first up-sampled video sequence;
display the first up-sampled video sequence on means for displaying during normal content viewing;
detect activation of a trick mode comprising one of the following: a fast forward mode; and a rewind mode; and
in response to detection of the activation of the trick mode:
up-sample at least part of a second one of the n1 down-sampled video sequences, thereby producing a second up-sampled video sequence; and
display the second up-sampled video sequence on the means for displaying instead of the first up-sampled video sequence during at least part of an activation period of the trick mode.
